(19) United States
(12) Patent Application Publication
(10) Pub. No.: US 2007/0211864 A1
(43) Pub. Date: Sep. 13, 2007

(54) System for remote integration and testing of a telephone loop

(76) Inventors: David R. Simmons, Springfield, IL (US); Paul Daunheimer, Aurora, IL (US); Russ Gratton, Hanover Park, IL (US); Robert Greenwell JR., Santa Ana, CA (US); Nikhil Marathe, Chicago, IL (US); Jody Nickol, Hanover Park, IL (US); Carol Seaman, Round Lake, IL (US); Glenn Storm JR., Dundee, IL (US)

Correspondence Address: BRINKS HOFER GILSON & LIONE, P.O. BOX 10395, CHICAGO, IL, 60610, US

(21) Appl. No.: 11/372,997

(22) Filed: Mar. 10, 2006

(51) Int. Cl. H04M 1/24; H04M 3/08; H04M 3/22

(52) U.S. Cl. 379/1.01

(57) ABSTRACT

A system for integration and testing of remote telephone loops allows the integration of remote telephone units to a serving switch located in a different central office facility. The remote integration provides integration of voice and data services, as well as a mechanized loop testing capability. Test signals may be provided via transport facilities from the serving switch to the remote terminal so that remote telephone loops can be tested and results passed to the metallic test bus unit of the serving switch.

### BACKGROUND OF THE INVENTION

1. Technical Field

The invention is related to telecommunications network integration. In particular, the invention is related to connecting telephone loop central office terminal (COT) facilities and a metallic loop testing circuit in one office to the telephone switch in another office using transport facilities.

2. Related Art

A loop COT in an office with a switching system capable of supporting an Integrated Digital Loop Carrier (BDLC) may be currently wired to switch GR303 or TR008 DLC Digital Signal 1 (DS1s) through DSX cross-connects. If the switching system cannot support the COT using IDLC, the COT is cabled to the Main Distributing Frame (MDF) and cross-connected to analog lines served from the switching system. This is known as universal pair gain (TR057) which is both inefficient and requires more floor space. Mechanized loop testing (MLT) of the remote lines may be accomplished by cross-connecting a switch metallic test bus (MTB) to the bypass pair of the remote terminal (RT). Without MLT access, the remote subscriber lines must be manually tested. Therefore, a need exists for remote integration with MLT capability.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a network system for remote integration and testing.

FIG. 2 illustrates a method for integration of a remote telephone loop with a central office terminal.

FIG. 3 illustrates a method for testing of a remote telephone loop by a central office terminal.

### DETAILED DESCRIPTION OF THE PREFERRED EMBODIMENTS

A system for remote integration and testing of a telephone loop includes a COT facility, a RT facility, a telephone switch located apart from the COT facility, a metallic test access (MTA) unit located in the COT facility, and transport facilities. The transport facilities are configured to transmit signals, including voice and data, and metallic loop test signals between the COT facility and the telephone switch. The metallic loop test circuit is configurable to simulate leads on a MTB unit in the central office via a D4 channel bank. The MTA unit allows a remote diagnostic of copper wire parameters, such as resonance length, open loop and short circuit tests, and bridge tap length tests.

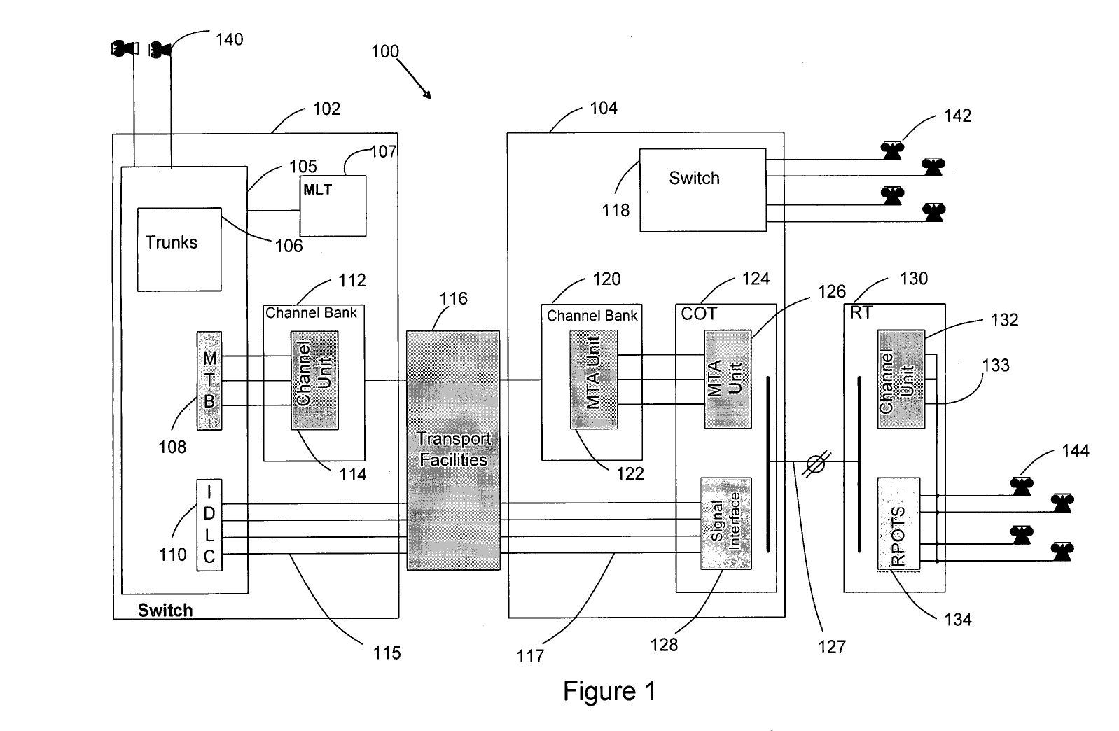

FIG. 1 illustrates a remote integration network system 100. The network 100 includes a first CO 102, a second CO 104, and transport facilities 116 in communication with the first CO 102 and the second CO 104. The first CO 102 includes a switching system 105 for switching telephone calls, a MLT platform for loop maintenance 107, and a channel bank 112 for converting analog signals to digital signals and back. The switching system 105 may include units 106 to provide services such as, but not limited to, analog or digital lines, analog or digital trunks, basic rate interface (BRI) integrated services digital network (ISDN), and primary rate interface (PRI) ISDN. The switching system 105 also includes a MTB 108 for performing MLT tests and a switch aggregation, or digital loop carrier, unit 110 for Integrated Digital Loop Carrier. A number of telephone units 140 may be connected to the switching system 105.

Mechanized Loop Testing (MLT) using test head hardware, such as the Tollgrade Digital Measurement Unit (DMU), is responsible for automated tests on telephone loops. The MLT test head hardware may include a loop measurement device configured for No Test Trunk (NTT) access to a switching system 105. MLT tests and analyzes services such as, but not limited to, analog lines, digital lines, and BRI lines in support of loop maintenance operations. The MLT 107 connects to the switching system 105 via the NTT and requests the switching system access a remote telephone loop by way of the MTB 108 and the RT bypass pair 133. Once connected to the remote telephone loop the MLT 107 test performs tests such as open loop failures, crossed loop failures, shorted loop failures, copper wire physical conditions, loop resonance, loop resonant length, and bridge tap (BT) length. MLT test results are relayed to the maintenance operator who requested the tests.

The MTB 108 may be implemented as a test bus controller unit (TBCU) and includes test leads for testing service failures on telephone loops. The MTB 108 may perform tests to diagnose open loop failures, crossed loop failures, shorted loop failures, copper wire physical conditions, loop resonance, loop resonant length, and bridge tap (BT) length. The MTB 108 may simulate test protocols that field service technicians may perform to diagnose loop conditions and potential failures.

The switch IDLC unit 110 may implement a TR008 or GR303 industry standard aggregation at the switching system 105. The switching system 105 may not be capable of terminating all calls received at once. The switch fabric in the switching system 105 may terminate a certain percentage of the full capacity for the switch, such as 30% or some other predetermined value. The aggregated signals may be transmitted by DS1 carriers.

The channel bank 112 includes a test circuit lead emulator 114. The test circuit lead emulator 114 may emulate tip ring inhibit (TRI) circuit leads on the MTB 108. The test circuit lead emulator 114, such as a Tollgrade MCU Channel Unit card, is installed in a channel bank 112, such as a D4 channel bank. The channel bank 112 may also include D5 channel banks or other channel bank technology. The channel bank 112 multiplexes and demultiplexes 24 Digital Signal 0 (DS0) signals into a single DS1 signal. A DS1 signal is composed of twenty-four 8-bit channels. Each DS0 channel is a 64 kbit/s DS0 multiplexed pseudo-circuit. The MTB 108 may require two DS0 channels out of the 24 DS0 channels. The test circuit lead emulator 114 sends a signal through the channel bank 112 to the remote CO 104, through the transport facilities 116. The digital signal may also include a Digital Signal 3 (DS3) or other digital signal.

The transport facilities 116 transmit the DS1 signals from the channel bank 112 in the first CO to a channel bank 120 in the second CO 104. The transport facilities 116 transmit a signal including a metallic loop testing signal, where the metallic loop testing signal is configurable in a format that may be processed by the channel bank 120. The transport facilities 116 may be a synchronous optical network (SONET), asynchronous fiber, or other fiber, or non-fiber, transport medium. SONET is a standard for communicating digital information using lasers or light emitting diodes (LEDs) over optical fiber as defined by GR-253-CORE from Telcordia. SONET allows the transport of large amounts of telephone and data traffic and to allow for interoperability between equipment from different vendors and service providers.

The second CO 104 may include a switching system 118, a channel bank 120, and a COT 124. The switching system 118 may provide services such as, but not limited to, analog or digital lines, analog or digital trunks, BRI ISDN, and PRI ISDN. The test circuit lead emulator 120, such as a Tollgrade MCU Channel Unit card, is installed in a channel bank 120, such as a D4 channel bank, D5 channel bank, or some other channel bank technology. The test circuit lead emulator 122 serves as a counterpart to the test circuit lead emulator 114 in the first CO 102. The channel bank 120 terminates DS1 signals from the transport facilities 116 and converts the DS1 signals from the channel bank 112 in the first CO 102. The test circuit lead emulator 122 in the second D4 channel bank 120 in the second CO 104 regenerates the test signal provided by the MTB 108 and passes it on to the MTA unit 126 of the COT 124. The MTA unit 126, such as a Tollgrade MCU Channel Unit card, is installed in COT 124. A number of remote telephone units 142 may be connected to the switching system 118.

The central office terminal 124 includes a MTA unit 126 for metallic loop testing, and a circuit aggregation module 128. The circuit aggregation module 128 may function as the interface to the IDLC unit 110 in the switching system 105 in the first CO 102. The circuit aggregation module 128 serves to aggregate the DS1 signals transmitted via DS1 signal carriers 117 transmitted through the transport facilities 116 via DS1 signal carriers 115. The circuit aggregation module 128 may be implemented as a GR303-standard or TR008-standard module.

The MTA unit 126, installed in the COT 124, is configurable as a test port for the COT 124. The MTA unit 126 may transmit the metallic loop test signal through a transport medium 127 to a MTA unit 132 installed in the RT 130. The MTA unit 132 serves as a counterpart to the MTA unit 126 in the COT 126. The MTA unit 132, such as a Tollgrade MCU Channel Unit card, is installed in RT 130. The MTA unit 132 interfaces with the RT bypass pair 133 which is used for testing remote telephone loops. The transport medium 127 may use fiber optic cable, copper wire cable, radio transmission, or any analogous medium. The metallic loop test signal is configurable to diagnose open loop failures, crossed loop failures, shorted loop failures, copper wire physical conditions, loop resonance, loop resonant length, and bridge tap (BT) length.

The RT 130 includes the bypass pair 133 and a quantity of “plain old telephone service” (POTS) modules 134. The POTS modules, such as the Litespan RPOTS module, are installed in the RT 130. The POTS modules 134 are in communication with a number of remote telephone units 144 which may require testing. The bypass pair 133 bridges onto the loops of the POTS module 134 to perform metallic loop test and respond back to the MTB 108 with any diagnostic information obtained from the tests.

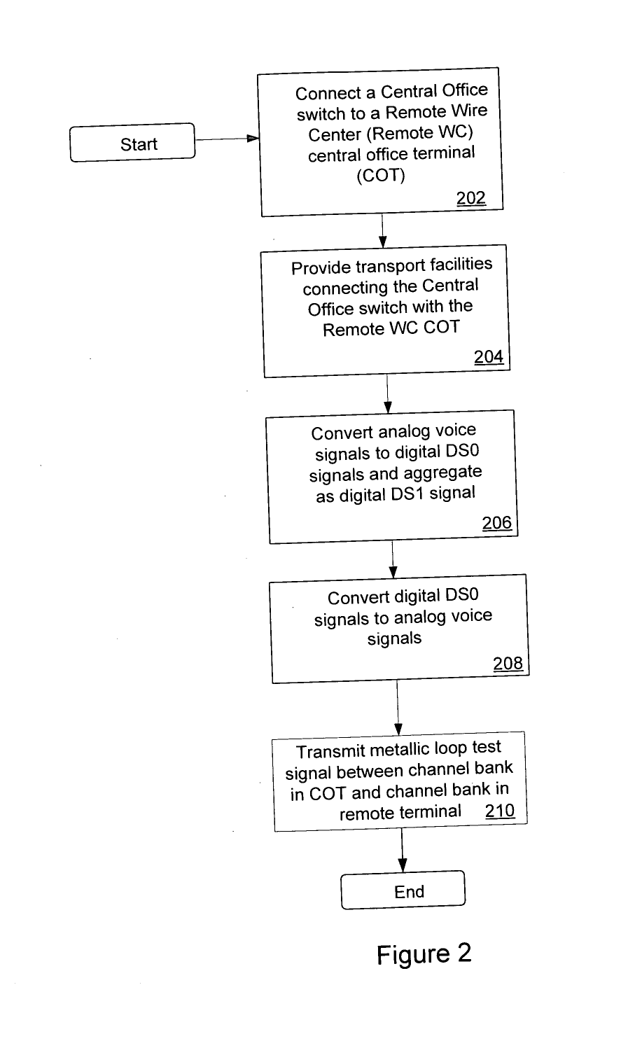

FIG. 2 illustrates a method for remotely integrating a telephone system. The network 100 connects a COT facility 124 such as CO 104 to a telephone switch 105 such as CO 102 located separately from the COT facility 102 (Act 202). As described in connection with FIG. 1, the COT facility 124 provides DS1 connections over the transport facilities 116 to the IDLC unit 110 in the switching system 105 in CO 102. The network 100 provides transport facilities 116 in communication with the COT facility 124 and the switching system 105 (Act 204). The transport facilities 116 may be a synchronous optical network (SONET), asynchronous fiber, or other fiber, or non-fiber, transport medium. The COT facility 124 interfaces with a transport medium 127 to a RT 130. Digital DS0 signals are converted to and from analog signals (Act 206) in a RT 130 and sent over telephone loops to and from the telephone units 144 (Act 208). The COT facility 124 may transmit a metallic loop test signal between the test circuit lead emulator 126 in the COT facility 124 and the test circuit lead emulator 132 in a remote terminal 130 via the transport medium 127 (Act 210).

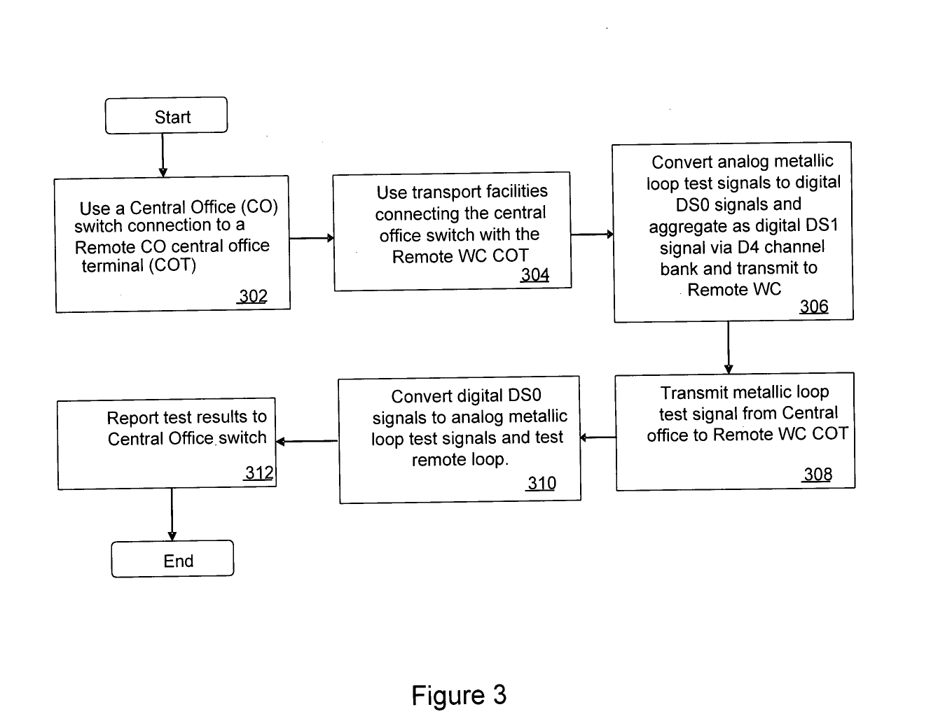

FIG. 3 illustrates a method for remotely testing a telephone loop. For convenience, the method of FIG. 3 is described in conjunction with the network of FIG. 1. The network 100 connects a COT facility 124 to a switching system 105 located separately from the COT facility 124 (Act 302). The network 100 provides transport facilities 116 in communication with the COT facility 124 and the switching system 105 (Act 302). The transport facilities 116 may be a synchronous optical network (SONET), asynchronous fiber, or other fiber, or non-fiber, transport medium. The transport facilities 116 may include a DS1 carrier supporting transmission of DS1 digital signals. The network 100 may provide a MTB unit 108 located in the switching system 105. The MTB unit 108 may generate signals configurable to test metallic loop parameters such as copper wire length, resonance length, open circuits, short circuits, bridge tap (BT) lengths, or other diagnostic parameters.

The network 100 converts analog metallic loop test signals to digital DS0 signals and aggregate as digital signals via the channel bank 112 (Act 306). The digital signal may include a DS0 digital signal, as part of a DS1 digital signal transmitted over the transport facilities 116. The metallic loop test signal may include a propagated signal for testing copper loop characteristics, such as copper resonance length, open loops, short circuits, or bridge tap (BT) lengths. The signal may emulate TRI leads from the MTB 108.

The CO 102 transmits the metallic loop test signal from the MTB 108 to the second CO COT 124 (Act 308). The channel bank 120 will convert the digital DS0 signals to analog metallic loop test signals and test the operability of the telephone units 144 (act 310). The second CO 104 may report test results from COT 124 to the MTB 108, such as by reporting loop diagnostic information (Act 312).

A remote integration and testing system may allow the integration of analog and/or digital phone services between a COT facility 124 and a serving switch 105. The testing system may allow a centralized and upgradeable platform for testing remote telephone units 144 from a different CO 102. The test circuit lead emulator 126 provided in the COT facility 124 may allow testing of telephone loops that formerly were performed by field service technicians.

Like the method shown in FIGS. 2-3, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the network 100, a communication interface, or any other type of non-volatile or volatile memory interfaced or resident to the network 100. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any unit that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A device for remotely connecting a telephone loop comprising:
a central office terminal facility;
a switching system located apart from the central office terminal facility;
a mechanized loop test unit located proximate to the switching system and in communication with the switching system;
a metallic test access unit located proximate to the central office terminal facility;
and transport facilities, where the transport facilities are configured to transmit a signal comprising voice and data and a metallic line testing signal between the central office terminal facility and the switching system.

2. The device of claim 1 where the signal comprises at least one of a digital signal or an analog signal.

3. The device of claim 2 where the digital signal comprises at least one Digital Signal 1 (DS1) signal, where a DS1 signal comprises at least one Digital Signal 0 (DS0) signal.

4. The device of claim 2 where the analog signal is convertible to a digital signal before transmission as part of a DS1 signal.

5. The device of claim 1 further comprising a channel bank.

6. The device of claim 5 where the channel bank is configurable to simulate test leads on the metallic test access unit.

7. The device of claim 6 where the channel bank comprises a D4 format channel bank.

8. The device of claim 1 where the metallic test access unit comprises a module that is positionable within the central office terminal facility or proximate to the central office terminal facility.

9. The device of claim 1 where the transport facilities comprise a synchronous optical network (SONET), an asynchronous fiber, a fiber transport medium, or a non-fiber transport medium.

10. The device of claim 1 where the mechanized loop test unit is configurable to:
request the switching system to access a remote telephone loop by way of the metallic test access unit and a remote terminal bypass pair; and
perform loop failure tests once connected to the remote telephone loop.

11. A method for integrating a telephone loop comprising:
connecting a central office terminal facility to a switching system located separately from the central office terminal facility;
providing transport facilities in communication with the central office terminal facility and the switching system;
transmitting signals comprising voice and data via a digital signal carrier in communication with the transport facilities; and
transmitting a metallic loop testing signal between the central office terminal facility and the switching system using the transport facilities.

12. The method of claim 11 further comprising providing a metallic test access unit located in the central office terminal facility or proximate to the central office terminal facility.

13. The method of claim 12 further comprising simulating test leads via a channel bank located proximate the switching system.

14. The method of claim 11 where transmitting the signal comprises transmitting a digital signal.

15. The method of claim 14 where transmitting the digital signal comprises transmitting a Digital Signal 1 (DS1) digital signal, or some other digital standard.

16. A method of testing a telephone loop comprising:
using a central office terminal facility connected to a switching system located separately from the central office terminal facility;
using transport facilities in communication with the central office terminal facility and the switching system;
transmitting signals comprising voice and data and a metallic loop testing signal between the central office terminal facility and the switching system using the transport facilities; and
testing an operability of the telephone loop with the metallic loop testing signal.

17. The method of claim 16 where testing the operability comprises simulating test leads on a channel bank located proximate the switching system.

18. The method of claim 17 where transmitting signals comprises transmitting signals between a channel bank proximate the switching system and a channel bank proximate the central office terminal facility.

19. A device for remotely connecting a telephone loop comprising:
a central office terminal facility;
a switching system located separately from the central office terminal facility;
means for testing a metallic loop located proximate to the central office terminal facility;
and means for transmitting a signal comprising voice and data and a test signal between the central office terminal facility and the switching system.

20. The device of claim 19 where the signal comprises at least one of a digital signal or an analog signal.

21. The device of claim 20 where the digital signal comprises at least one Digital Signal 1 (DS1) signal, where a DS1 signal comprises at least one Digital Signal 0 (DS0) signal.

22. The device of claim 20 where the analog signal is convertible to a digital signal before transmission as part of a DS1 signal.

23. The device of claim 19 further comprising means for receiving the digital signal.

24. The device of claim 19 where the means for receiving the digital signal comprises means for simulating test leads on the means for testing a metallic loop.

25. The device of claim 18 further comprising means for connecting the central office terminal facility to the switching system located separately from the central office terminal facility.

26. The device of claim 25 means for connecting the central office terminal facility to the switching system located separately from the central office terminal facility comprises means for connecting a channel bank proximate the switching system to a channel bank proximate the central office terminal facility.
